(19) United States
(12) Patent Application Publication
(10) Pub. No.: US 2003/0210284 A1
(43) Pub. Date: Nov. 13, 2003

(54) Navigational display of hierarchically structured data

(75) Inventors: Stanley E. Vandruff, King George, VA (US); Robert R. Donath, Dahlgren, VA (US)

Correspondence Address: Naval Surface Warfare Center, Office of Counsel (Patents) (Code XDC1), 17320 Dahlgren Road, Dahlgren, VA, 22448-5100, US

(73) Assignee: Government of the United States of America

(21) Appl. No.: 10/407,309

(22) Filed: Apr. 4, 2003

Related U.S. Application Data
(60) Provisional application No. 60/379,683, filed on May 10, 2002.

(51) Int. Cl. G09G 5/00

(52) U.S. Cl. 345/853

(57) ABSTRACT

The navigational display of hierarchically structured data, including elements contained within constructs, is disclosed. A center node is displayed as one of the elements or constructs. The center node has as first-level nodes elements and/or constructs that are contained within and/or contain the center node. The first-level nodes are displayed within a concentric ring around the center node, and spokes are displayed between the center node and the first-level nodes. The first-level nodes may each have as second-level nodes those of the elements and/or the constructs that are contained within and/or contain the first-level node. The second-level nodes of such first-level nodes are displayed within another concentric ring around the center node. Spokes are displayed between each of these first-level nodes and the second-level nodes of the first-level node. A user may navigate within the display of the data, including zooming, panning, rotating, and expanding and collapsing the data displayed.

### RELATED APPLICATIONS

This patent application claims the benefit of and priority to the previously filed provisional patent application entitled “Navigational Viewer for Hierarchically Structured Data,” filed on May 10, 2002, and assigned serial No. 60/379,683.

### FIELD OF THE INVENTION

This invention relates generally to hierarchically structured data, and more particularly to the navigational display of such data.

### BACKGROUND OF THE INVENTION

The ability to visualize and navigate large data structures can be crucial to many tasks. Practical examples of large data structures include the file systems of personal computers, database query results, organizational charges of large companies, and hypermedia such as the World-Wide Web (WWW) of the Internet. Other examples include game decision trees, flowcharts, electrical power flow, and telephone call volume.

Each data structure typically places unique demands on the analyst responsible for analyzing the structure. Each data structure may, for instance, require different parameters for optimum visual clarity. Much research as gone into optimal placement algorithms. However, such solutions rely on a computer determining how to pack the desired information into the available space. Aside from the difficulty and complexity of such approaches, their inherent automation imposes unnecessary limitations on the user. Information visualization is inherently interactive, and optimization that requires a complex algorithm often only comes easily to human users when they have the necessary tools available.

For these and other reasons, therefore, there is a need for the present invention.

### SUMMARY OF THE INVENTION

The invention relates to the navigational display of hierarchically structured data. The hierarchically structured data include elements, such as data files, contained within constructs, such as directories. Each construct may contain one or more elements and/or one or more other constructs. Thus, each construct except a root construct, as well as each element, is contained by a construct. A method of the invention displays such hierarchically structured data.

The method displays a center node as one of the elements or constructs. The center node has as first-level nodes those of the elements and/or those of the constructs that are contained within the center node and/or that contain the center node. The first-level nodes are displayed within a first-level concentric ring around the center node, and spokes are displayed between the center node and the first-level nodes.

The first-level nodes may each have as second-level nodes those of the elements and/or those of the constructs that are contained within the first-level node and/or that contain the first-level node. The second-level nodes of such first-level nodes are displayed within a second-level concentric ring around the center node outside of the first-level concentric ring. Spokes are displayed between each of these first-level nodes and the second-level nodes of the first-level node.

Such display can be extended for third-level nodes, fourth-level nodes, and so on. The user can navigate within the display in one embodiment. For instance, clicking on a node causes it to become the new center node, with new first-level nodes, second-level nodes, and so on, displayed relative to the new center node. Rotation of the nodes around the center node can be achieved. The display may be zoomed in and zoomed out of by the user. The user may pan within the display, as well as expand or collapse the display axially or radially.

Embodiments of the invention provide for advantages over the prior art. The graphical display of the hierarchically structured data allows the user to grasp the overall structure of the constructs within which the elements are contained. The user is able to view the elements of more than one construct at a time, allowing the user to also grasp where most of the elements are stored, for instance. The user can zoom in to view the data in detail, as well as zoom out to obtain an overall perspective of the hierarchically structured data. The user is provided with complete control over the presentation of the data, including, but not limited to, zoom level, rotation, labeling, as well as the size, color, and clustering of nodes.

Still other aspects, embodiments, and advantages of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a flowchart of a method for navigationally displaying hierarchically structured data, according to an embodiment of the invention.

FIGS. 2-10 are diagrams showing the navigational display of hierarchically structured data, according to varying embodiments of the invention.

FIG. 11 is a diagram of a system for navigationally displaying hierarchically structured data, according to an embodiment of the invention.

### DETAILED DESCRIPTION OF THE INVENTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

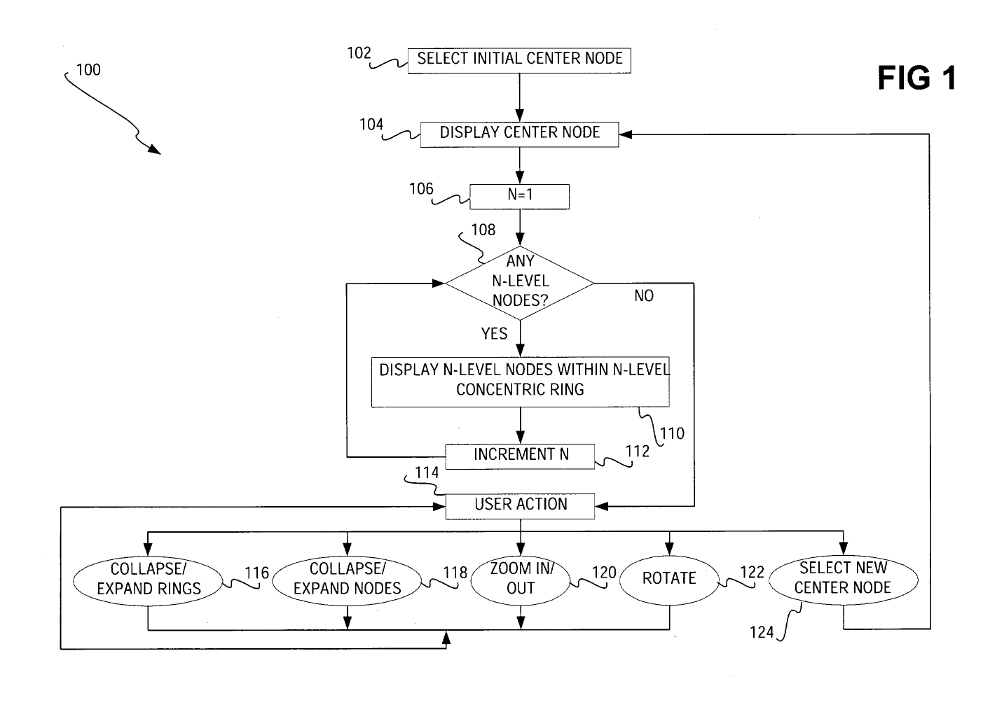

FIG. 1 shows a method 100 for navigationally displaying hierarchically structured data, according to an embodiment of the invention. The method 100 may be implemented as a computer program stored on a computer-readable medium, such as a removable or fixed storage device, a volatile or non-volatile storage device, and so on. The hierarchically structured data includes elements that are contained within constructs. Each construct can contain one or more elements and/or one or more constructs. Thus, each construct except the root construct, as well as each element, is contained by a construct. In one embodiment, the elements may be data files, and constructs may be directories or folders. However, the invention is applicable to other types of hierarchically structured data as well.

The method 100 first selects an initial center node (102). For instance, the center node may be initially selected as the root construct. The root construct is the construct that is not contained by any other constructs, and that ultimately contains all other constructs and all the elements. The center node is then displayed (104). A counter, N, is set equal to one (106), and the method 100 determines whether there are any N-level nodes (108). For instance, where N is equal to one, the method 100 determines whether there are any first-level nodes. First-level nodes are elements and/or constructs that are directly contained by the center node. If there are such first-level nodes, they are displayed within an N-level concentric ring—that is, a first-level concentric ring—around the center node (110). N is then incremented (112).

In the second pass through 108, the method 100 determines whether there are any second-level nodes (108). Second-level nodes are elements and/or constructs that are directly contained by any first-level node, or that directly contain any first-level node. Assuming there are second-level nodes, the method 100 displays them within a second-level concentric ring outside of the first-level concentric ring (110), and N is again incremented (112). This process is repeated until there are no N-level nodes to be displayed (108), in which case the method 100 proceeds to 114. That there are no N-level nodes to be displayed can mean that there are actually no N-level nodes. Alternatively, it can mean that no more nodes can be displayed on the display, such as a monitor. That is, there may still be N-level nodes, but there is no room left on the display to display them.

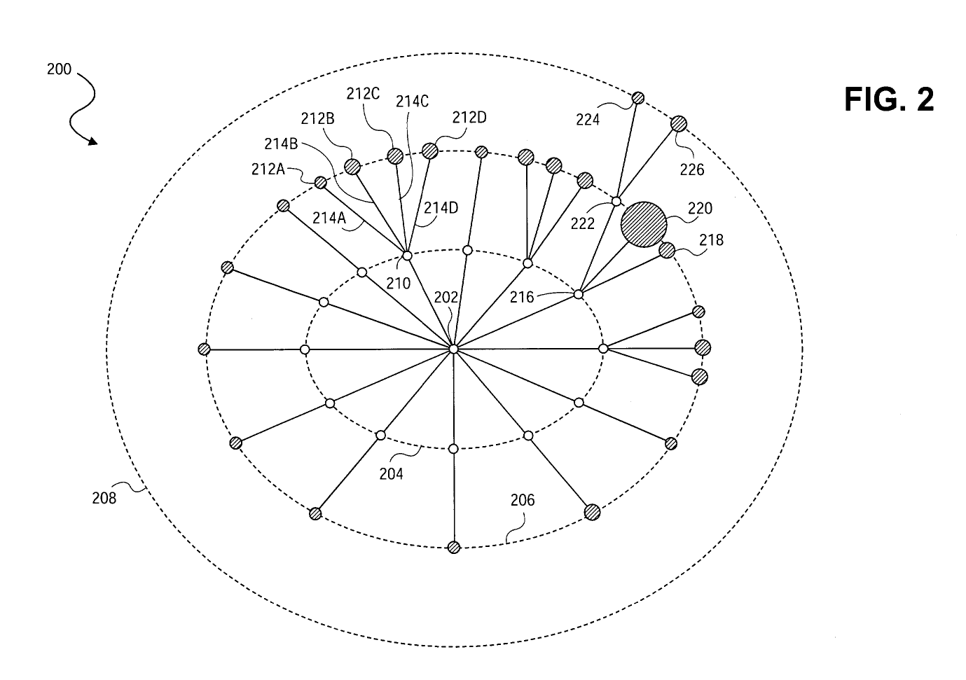

FIG. 2 shows hierarchically structured data 200 that is displayed in accordance with the method 100 as has thus far been described. The center node 202 is surrounded by a first-level concentric ring 204, a second level-concentric ring 206, and a third-level concentric ring 208. Preferably, the rings 204, 206, and 208 are in actuality not displayed, but for illustrative clarity they are present in FIG. 2.

In FIG. 2, constructs are depicted as hollow circles, whereas elements are depicted as filled-in circles having sizes proportional to one of their properties. For instance, where the elements are data files, the circles may have sizes proportional to their sizes. The nodes may also be differently colored, depending on their properties. For example, for elements that are data files, their nodes may be differently colored based on their type. The names of the constructs and the elements may also be displayed, but for illustrative clarity they are omitted in FIG. 2. Furthermore, the elements may have shapes that are set based on the properties of the elements, such as circles, stars, squares, and so on. Alternatively, the elements may have icons set based on their properties. The spokes connecting elements may also have their color, weight, and/or style altered based on the elements' properties.

The first-level ring 204 contains nodes that are constructs and elements contained by or that contain the center node 202. The center node 202 is specifically a root construct, such that the nodes of the first-level ring 204 in FIG. 2 are actually constructs and elements contained by the center node 202. The second-level ring 206 contains nodes that are constructs and elements contained by or that contain any of the nodes of the first-level ring 204, whereas the third-level ring 208 contains nodes that are constructs and elements contained by or that contain any of the nodes of the second-level ring 206.

The levels 204, 206, and 208 are ordered in accordance with their relationship to the center node 202. Thus, because the center node 202 is in FIG. 2 the root construct, the second-level ring 206 contains nodes that are constructs and elements contained by any of the nodes of the first-level ring 204 in actuality, and the third-level ring 208 contains nodes that are constructs and elements contained by any of the nodes of the second-level ring 206. As will be described, where the center node does not correspond to the root construct, the rings 204, 206, and 208 may contain nodes that are constructs and elements contained by and/or that contain the center node 202, the ring 204, and the ring 206, respectively.

Therefore, the remainder of the description of FIG. 2 specifically refers to N-level nodes containing (N+1)-level nodes, and the center node containing the first-level nodes. However, where the center node does not correspond to the root construct, this more generally can mean that N-level nodes can contain and/or be contained by (N+1)-level nodes, and the center node can contain and/or be contained by first-level nodes. In general, an N-level node is a node that is present in the N-level concentric ring surrounding the center node 202. Each N-level concentric ring is outside any M-level concentric ring, where M<N.

Spokes, or lines, are preferably displayed between nodes of successive rings, and between the center node 202 and the first-level ring 204, to show the containing relationship among such nodes. For instance, the center node 202 has spokes between it and each of the nodes of the first-level ring 204, to indicate that it contains each of these nodes, where the center node 202 is the root construct. The spokes between the nodes of the first-level ring 204 and the second-level ring 206 indicate which of the first-level nodes contain which of the second-level nodes. Similarly, the spokes between the nodes of the second-level ring 206 and the third-level ring 208 indicate which of the second-level nodes contain which of the third-level nodes.

For example, the first-level node 210 is a construct that is contained by the root construct to which the center node 202 corresponds. The first-level node 210 in turn contains the second-level nodes 212A, 212B, 212C, and 212D, as indicated by the spokes 214A, 214B, 214C, and 214D, respectively. As another example, the center node 202 contains the first-level node 216, which contains the second-level nodes 218, 220, and 222. The second-level node 222 in turn contains the third-level nodes 224 and 226. Only where the center node 202 corresponds to the root construct are N-level nodes directly or indirectly contained by M-level nodes, where M<N.

Referring back to FIG. 1, the user performs an action, preferably with a pointing device such as a mouse, to navigate the display of nodes (114). The action may be a gesture, which is defined as a user action performed relative to a pointing device whereby the user presses and holds a button of the pointing device, and then causes the pointing device to indicate movement in a given direction. Preferably, such gestures allow the user to cause the method 100 to perform the actions 116, 118, 120, and 122. The user may also select a new node by clicking a button of the pointing device when a pointer is positioned over the node, as the action 124.

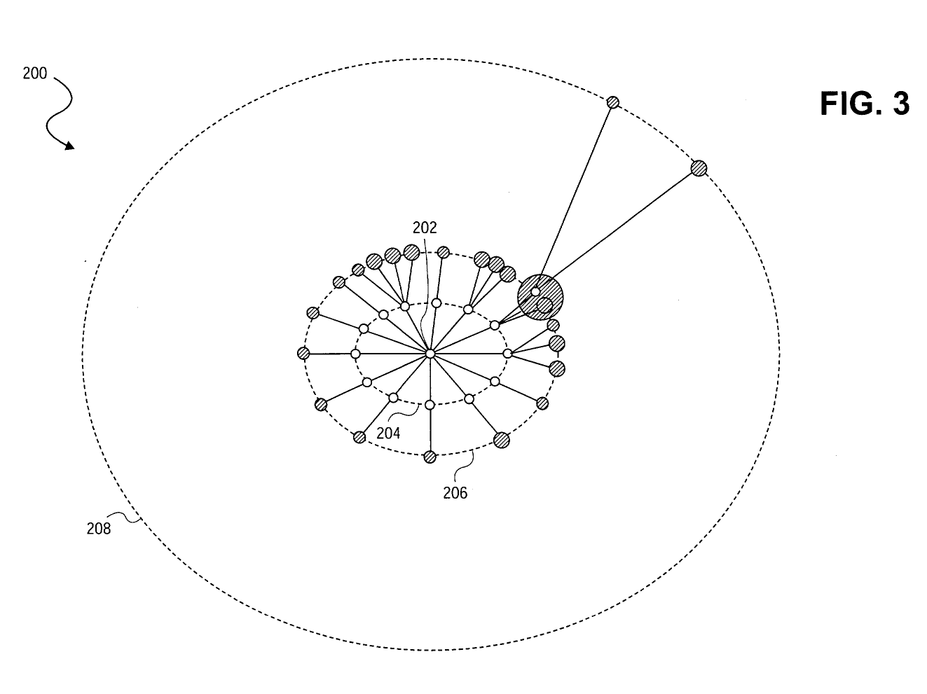

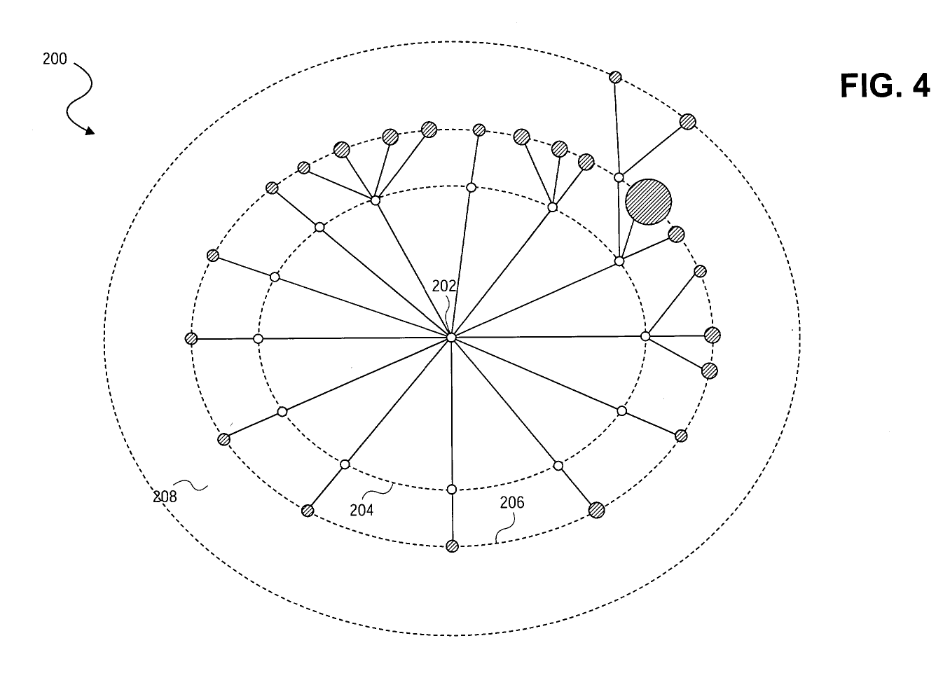

The action 116 is the collapsing or expanding of the rings surrounding the center node, which is a radial change. This is shown with exemplary reference to FIGS. 3 and 4. In FIG. 3, the rings 204, 206, and 208 have been collapsed relative to the center node 202, as compared to the rings 204, 206, and 208 of FIG. 2 relative to the center node 202 of FIG. 2. In FIG. 4, the rings 204, 206, and 208 have been expanded relative to the center node 202, as compared to the rings 204, 206, and 208 of FIG. 3 relative to the center node 202 of FIG. 3.

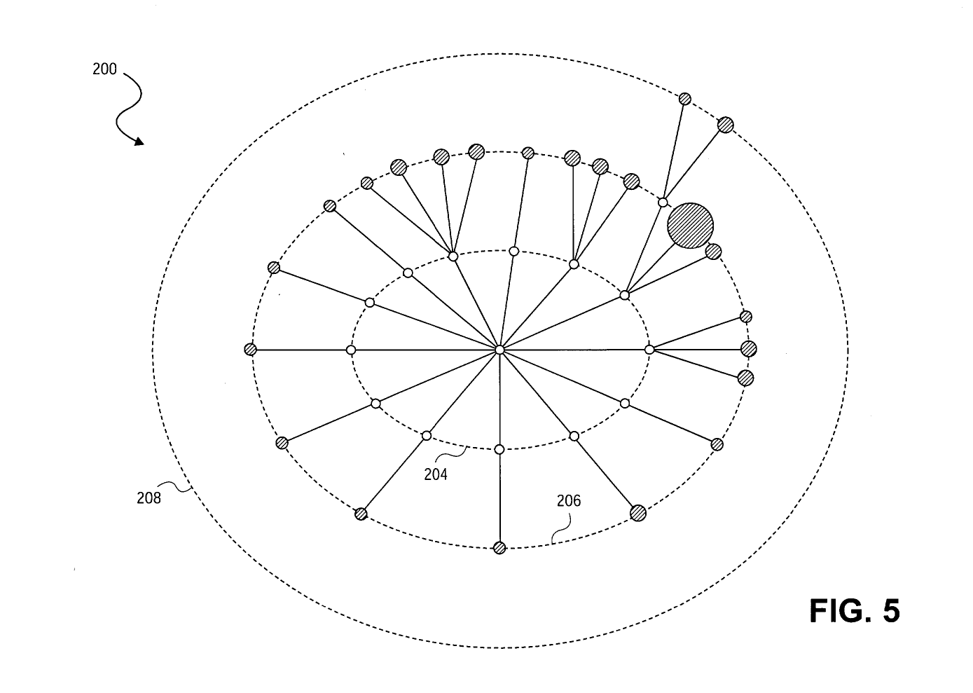

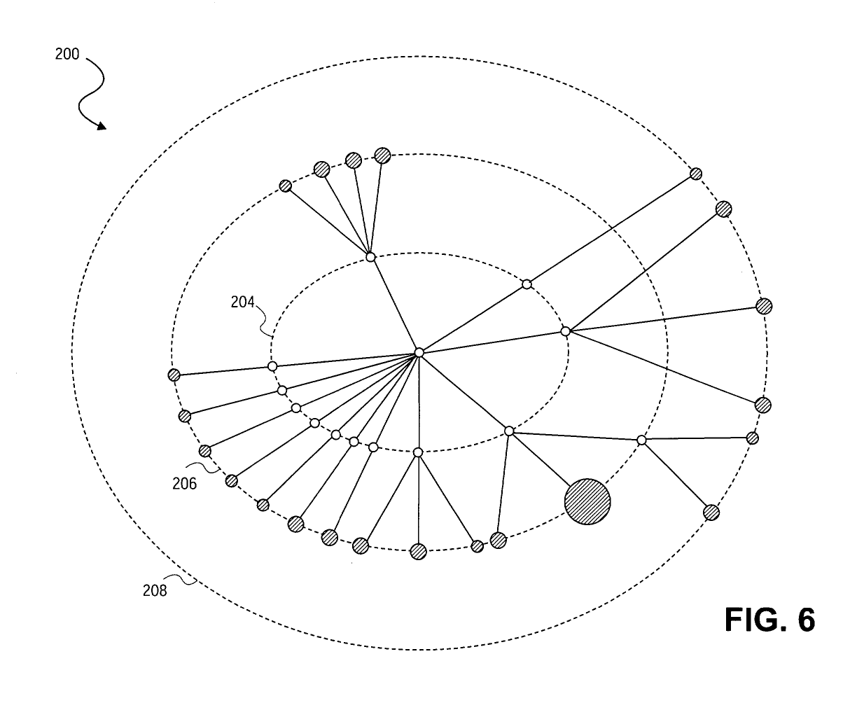

Referring back to FIG. 1, the action 118 is the collapsing or expanding of the nodes relative to—that is, within or on—their rings, without the rings themselves collapsing or expanding relative to the center node, which is an angular change. This is shown with exemplary reference to FIGS. 5 and 6. In FIG. 5, the nodes of the rings 204, 206, and 208 have been expanded relative to their rings 204, 206, and 208, respectively. That is, the nodes of outer rings are more spread out. By comparison, in FIG. 6, the nodes of the rings 204, 206, and 208 have been collapsed relative to their rings 204, 206, and 208, respectively. That is, the nodes of outer rings are more close together. In both FIGS. 5 and 6, the rings 204, 206, and 208 themselves have not moved relative to the center node 202.

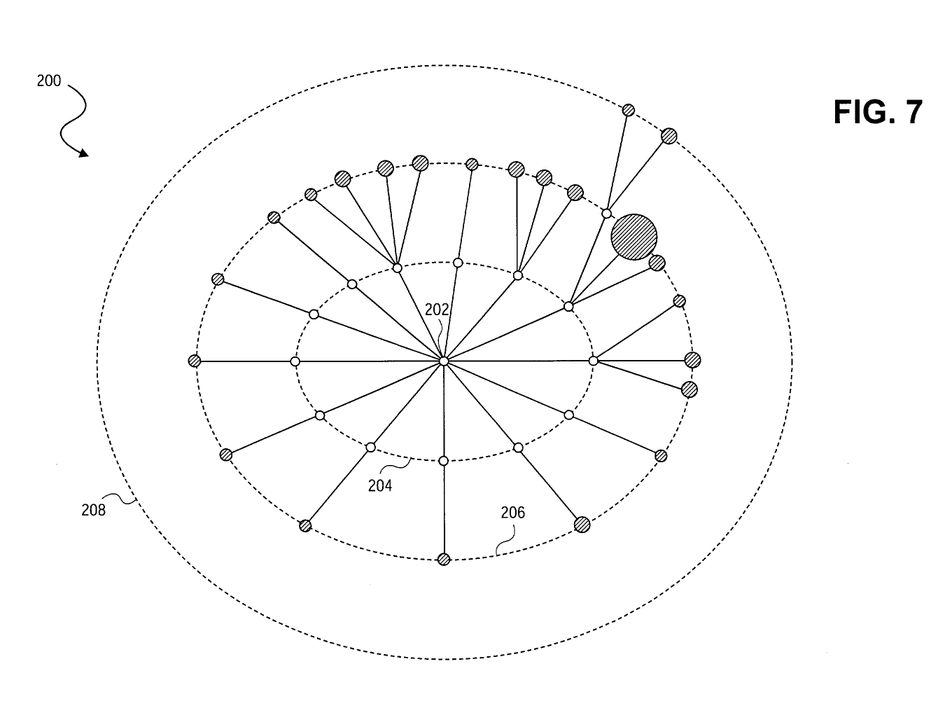

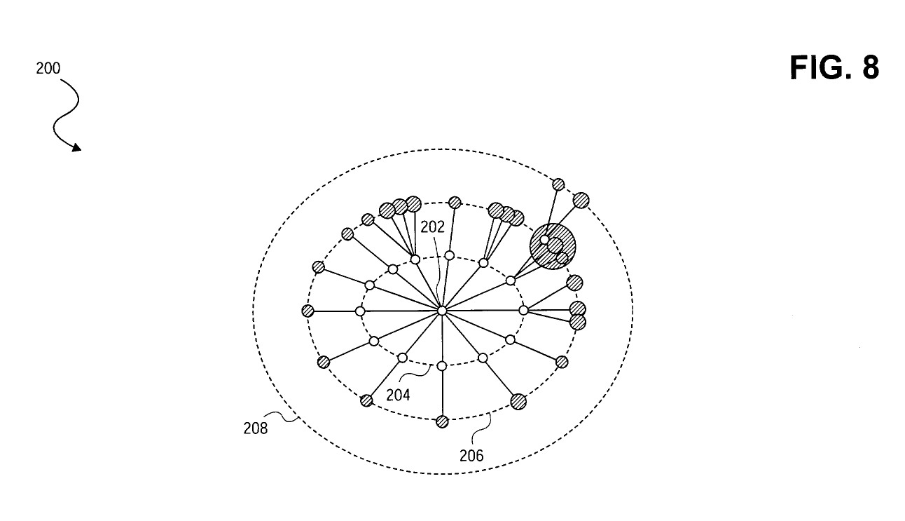

Referring back to FIG. 1, the action 120 is the zooming in or zooming out within the display of the hierarchically structured data. This is shown with exemplary reference to FIGS. 7 and 8. In FIG. 7, the display of the hierarchically structured data 200 has been zoomed in. By comparison, in FIG. 8, the display of the hierarchically structured data 200 has been zoomed out.

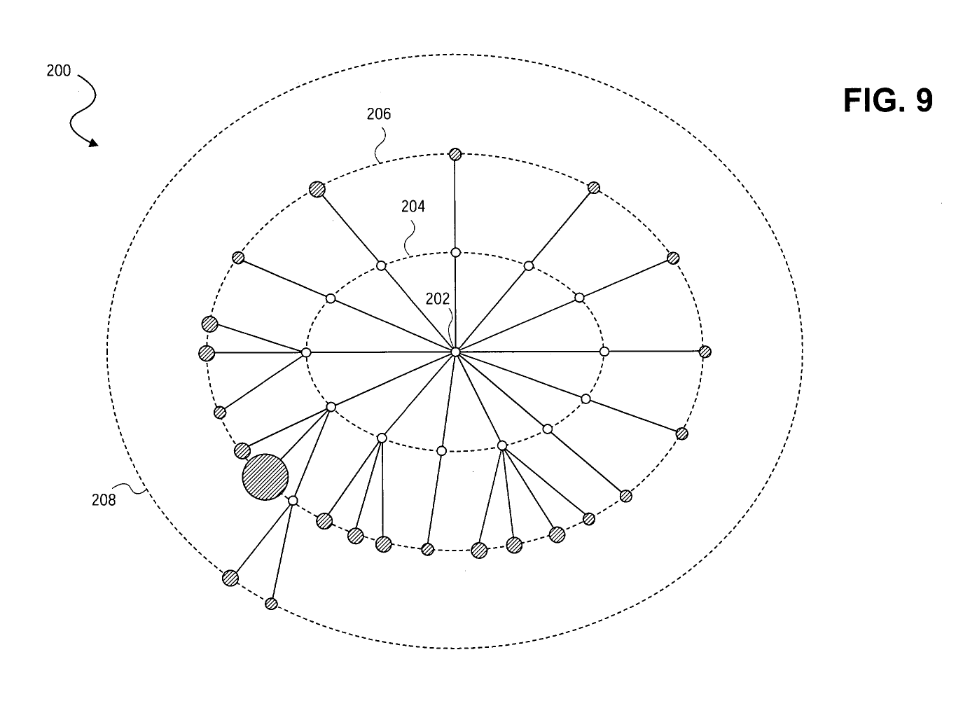

Referring back to FIG. 1, the action 122 is the rotation of the nodes within the rings, either clockwise or counter-clockwise, around the center node as a point of rotation. This is shown with exemplary reference to FIG. 9. In FIG. 9, the nodes within the concentric rings 204, 206, and 208 have been rotated around the center node 202, as compared to the nodes within the concentric rings 204, 206, and 208 of FIG. 2.

Referring back to FIG. 1, the action 124 is the selection of a new center node. Once the user selects a new center node, the display of the hierarchically structured data is re-configured relative to the new center node, by performing 104, 106, and iteratively performing 108, 110, and 112 as has been described. Thus, the new first-level nodes are constructs or elements directly contained within and/or directly contained by the new center node, the new second-level nodes are construct or elements directly contained within and/or directly contained by the new first-level nodes, and so on.

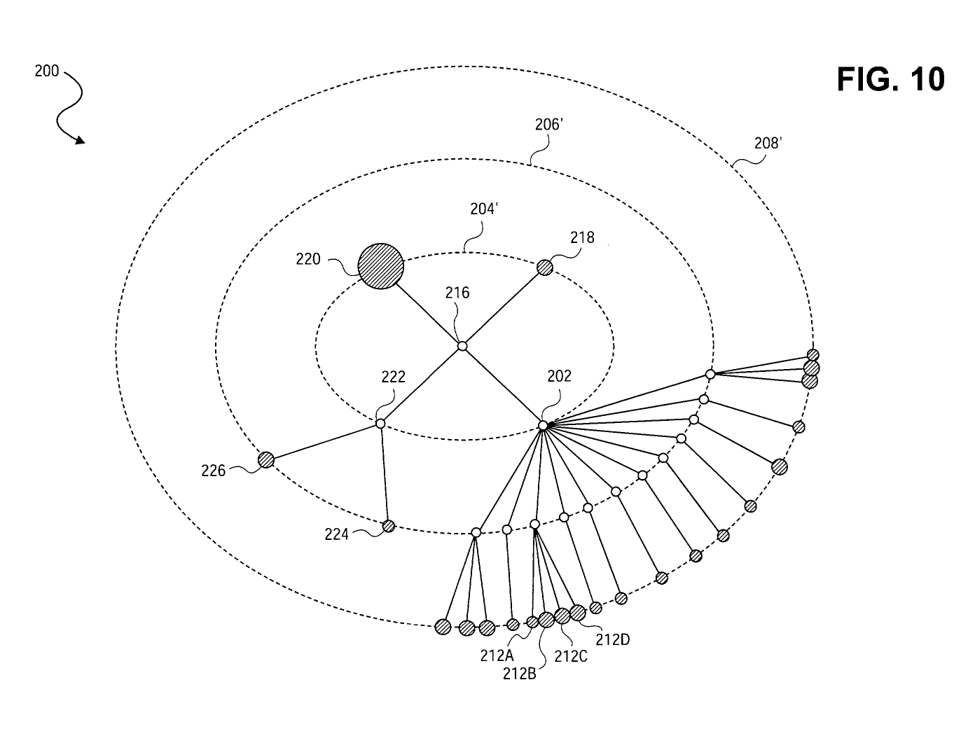

FIG. 10 shows an example of the node 216 of FIG. 2 being selected as the new center node 216. The nodes 218, 220, 222, and 202 are thus now the new first-level nodes within the new first-level concentric ring 204′. The nodes 218 and 220 specifically correspond to elements that are contained by the new center node 216, whereas the node 222 specifically corresponds to a construct contained by the new center node 216. The node 202, which is the center node 202 in FIG. 2, is now a first-level node corresponding to a construct that contains the construct to which the new center node 216 corresponds.

The nodes within the second-level concentric ring 206′ correspond to elements and/or constructs that are contained by and/or that contain the elements and/or constructs to which the nodes within the first-level concentric ring 204′ correspond. Similarly, the nodes within the third-level concentric ring 208′ are contained by and/or contain nodes within the second-level concentric ring 206′. Thus, the node 210 is now a second-level node, whereas it is a first-level node in FIG. 2, and the nodes 212A, 212B, 212C, and 212D are now third-level nodes, whereas they are second-level nodes in FIG. 2.

The perspective with which the hierarchically structured data 200 is displayed in FIG. 10 is with respect to the new center node 216. Thus, the first-level ring 204′ includes nodes contained by and/or containing the center node 216. Similarly, the second-level ring 206′ includes nodes contained by and/or containing the nodes of the first-level ring 204′, and the third-level ring 208′ includes nodes contained by and/or containing the nodes of the second-level ring 206′.

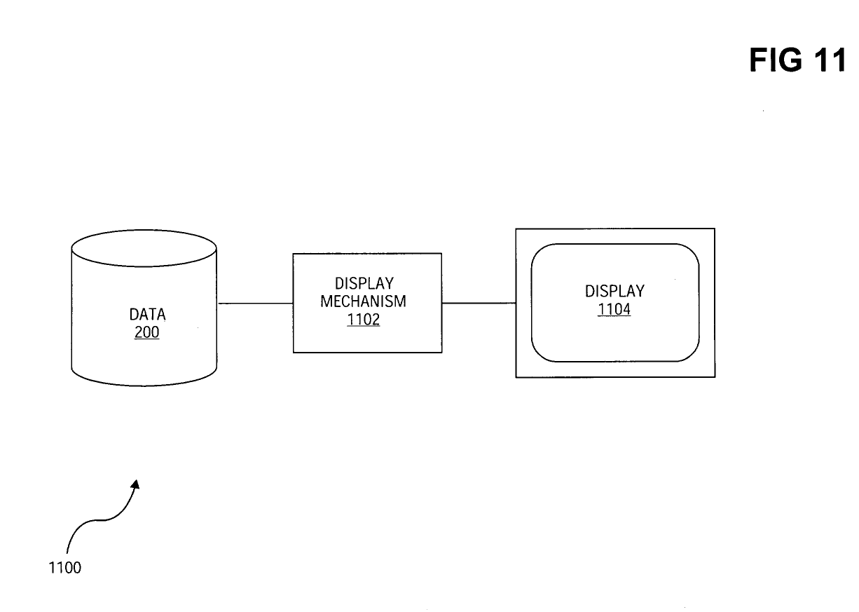

FIG. 11 shows a system 1100 for navigationally displaying hierarchically structured data, according to an embodiment of the invention. The system 1100 includes a display mechanism 1102, a display 1104, and the hierarchically structured data 200. The display mechanism 1102 may be implemented in software and/or hardware, and may include a computer having a computer program running thereon. The computer program may be stored on a computer-readable medium. Likewise, the hierarchically structured data 200 may be stored on a computer-readable medium. The display 1104 may be a monitor. The mechanism 1102 thus navigationally displays the data 200 on the display 1104, in accordance with the method 100 of FIG. 1 that has been described. The mechanism 1102 may be considered the means for performing this functionality as well.

It is noted that, although specific embodiments have been illustrated and described herein, it will be appreciated by those of ordinary skill in the art that any arrangement is calculated to achieve the same purpose may be substituted for the specific embodiments shown. This application is intended-to cover any adaptations or variations of the present invention. Therefore, it is manifestly intended that this invention be limited only by the claims and equivalents thereof.

We claim:

1. A method for displaying hierarchically structured data including a plurality of elements hierarchically contained within a plurality of constructs, each construct containing one or more elements and/or one or more other constructs such that each construct except a root construct of the plurality of constructs and each element is contained by one of the plurality of constructs, the method comprising:
displaying a center node as one of the plurality of elements and the plurality of constructs, the center node having as first-level nodes those of the plurality of elements and/or those of the plurality of constructs that are contained within the center node and/or that contain the center node;
displaying the first-level nodes within a first-level concentric ring around the center node and displaying spokes between the center node and the first-level nodes, each of one or more of the first-level nodes having as second-level nodes those of the plurality of elements and/or those of the plurality of constructs that are contained within the first-level node and/or that contain the first-level node; and,
displaying the second-level nodes of the one or more of the first-level nodes within a second-level concentric ring around the center node outside of the first-level concentric ring and displaying spokes between each of the one or more of the first-level nodes and the second-level nodes of the first-level node.

2. The method of claim 1, wherein each of one or more of the second-level nodes has as third-level nodes those of the plurality of elements and/or those of the plurality of constructs that are contained within the second-level node and/or that contain the second-level node, the method further comprising displaying the third-level nodes of the one or more of the second-level nodes within a third-level concentric ring around the center node outside of the second-level concentric ring and displaying spokes between each of the one or more of the second-level nodes and the third-level nodes of the second-level node.

3. The method of claim 2, wherein each of one or more of the third-level nodes has as fourth-level nodes those of the plurality of elements and/or those of the plurality of constructs that are contained within the third-level node and/or that contain the third-level node, the method further comprising displaying the fourth-level nodes of the one or more of the third-level nodes within a fourth-level concentric ring around the center node outside of the third-level concentric ring and displaying spokes between each of the one or more of the third-level nodes and the fourth-level nodes of the third-level node.

4. The method of claim 1, wherein each of the center node, the first-level nodes, and the second-level nodes that is one of the plurality of elements is displayed differently than each of the center node, the first-level nodes, and the second-level nodes that is one of the plurality of constructs is displayed.

5. The method of claim 1, wherein displaying each of the center node, the first-level nodes, and the second-level nodes that is one of the plurality of elements comprises displaying the node with a size proportional to a property of the node.

6. The method of claim 1, wherein displaying each of the center node, the first-level nodes, and the second-level nodes that is one of the plurality of elements comprises displaying the node with a color corresponding to a property of the node.

7. The method of claim 1, further comprising setting a shape based on a property of a node.

8. The method of claim 1, further comprising setting an icon based on a property of a node.

9. The method of claim 1, further comprising altering at least one of a color, a weight, and a style of a spoke based on a property of a node.

10. The method of claim 1, further comprising in response to a user activating one of the first-level nodes and the second-level nodes, displaying the activated node as a new center node, and displaying new first-level nodes within a new first-level concentric ring and new second-level nodes within a new second-level concentric ring around the new center node.

11. The method of claim 1, further comprising in response to a user performing a predetermined gesture relative to a pointing device, rotating the first-level nodes within the first-level concentric ring and the second-level nodes within the second-level concentric ring around the center node.

12. The method of claim 1, further comprising in response to a user performing a predetermined gesture relative to a pointing device, displaying the center node, the first-level nodes, and the second-level nodes in one of a zoomed-in and zoomed-out manner.

13. The method of claim 1, further comprising in response to a user performing a predetermined gesture relative to a pointing device, one of expanding and collapsing the first-level nodes and the second-level nodes.

14. The method of claim 1, further comprising in response to the user performing the predetermined gesture relative to the pointing device, one of expanding and collapsing the first-level concentric ring and the second-level concentric ring.

15. The method of claim 1, further comprising in response to a user performing a predetermined gesture relative to a pointing device, panning the center node, the first-level nodes, and the second-level nodes as displayed.

16. The method of claim 1, further comprising initially selecting as the center node the root construct.

17. The method of claim 1, wherein each element comprises a data file and each construct comprises a directory, such that the plurality of elements comprises a plurality of data files hierarchically organized within a plurality of directories that the plurality of constructs comprises, the root construct comprising a root directory.

18. A computer-readable medium having a computer program stored thereon to perform a method for displaying hierarchically structured data including a plurality of elements hierarchically contained within a plurality of constructs, each construct containing one or more elements and/or one or more other constructs such that each construct except a root construct of the plurality of constructs and each element is contained by one of the plurality of constructs, the method comprising:
displaying a center node as one of the plurality of elements and the plurality of constructs, the center node having as first-level nodes those of the plurality of elements and/or those of the plurality of constructs that are contained within the center node and/or that contain the center node;
displaying the first-level nodes within a first-level concentric ring around the center node, each of one or more of the first-level nodes having as second-level nodes those of the plurality of elements and/or those of the plurality of constructs that are contained within the first-level node and/or that contain the first-level node; and,
displaying the second-level nodes of the one or more of the first-level nodes within a second-level concentric ring around the center node outside of the first-level concentric ring.

19. The medium of claim 18, further comprising displaying spokes between the center node and the first-level nodes, and between each of the one or more of the first-level nodes and the second-level nodes of the first-level node.

20. The medium of claim 18, wherein each of one or more of the second-level nodes has as third-level nodes those of the plurality of elements and/or those of the plurality of constructs that are contained within the second-level node and/or that contain the second-level node, the method further comprising displaying the third-level nodes of the one or more of the second-level nodes within a third-level concentric ring around the center node outside of the second-level concentric ring.

21. A system comprising:
a display;
a computer-readable medium storing hierarchically structured data including a plurality of elements hierarchically contained within a plurality of constructs, each construct containing one or more elements and/or one or more other constructs such that each construct except a root construct of the plurality of constructs and each element is contained by one of the plurality of constructs; and,
a display mechanism to
display on the display a center node as one of the plurality of elements and the plurality of constructs, the center node having as first-level nodes those of the plurality of elements and/or those of the plurality of constructs that are contained within the center node and/or that contain the center node;
display on the display the first-level nodes within a first-level concentric ring around the center node and displaying spokes between the center node and the first-level nodes, each of one or more of the first-level nodes having as second-level nodes those of the plurality of elements and/or those of the plurality of constructs that are contained within the first-level node and/or that contain the first-level node; and,
display on the display the second-level nodes of the one or more of the first-level nodes within a second-level concentric ring around the center node outside of the first-level concentric ring and displaying spokes between each of the one or more of the first-level nodes and the second-level nodes of the first-level node.

22. The system of claim 21, wherein each element comprises a data file and each construct comprises a directory, such that the plurality of elements comprises a plurality of data files hierarchically organized within a plurality of directories that the plurality of constructs comprises, the root construct comprising a root directory.

23. The system of claim 21, wherein the display mechanism comprises a computer-readable medium having a computer program stored thereon.
